(19) United States
(12) Patent Application Publication
(10) Pub. No.: US 2015/0122336 A1
(43) Pub. Date: May 7, 2015

(54) Systems and Methods for Decreasing Abrasive Wear in a Pipeline that is Configured to Transfer a Slurry

(71) Applicant: EXXONMOBIL UPSTREAM RESEARCH COMPANY, Houston, TX (US)

(72) Inventors: Matthew A. Dawson, Sugar Land, TX (US); Douglas P. Fairchild, Sugar Land, TX (US); Mario L. Macia, Bellaire, TX (US)

(21) Appl. No.: 14/388,491

(22) PCT Filed: Mar. 15, 2013
(86) PCT No.: PCT/US13/32541

§ 371 Date: Sep. 26, 2014

Related U.S. Application Data
(60) Provisional application No. 61/641,065, filed on May 1, 2012.

(51) Int. Cl. F17D 1/08; F16L 57/06; F16L 55/04

(52) U.S. Cl. CPC F17D 1/088; F16L 55/04; F16L 57/06
USPC 137/1; 138/140

(57) ABSTRACT

Systems and methods for decreasing abrasive wear in a pipeline that is configured to transfer a slurry that includes a liquid and solid particles. The pipeline includes a pipe that defines a pipeline conduit and an energy dissipation layer that is within the pipeline conduit and through which a portion of the slurry flows. The slurry may flow at high velocity and/or with high turbulence, and it may contain hydrocarbons. The systems and methods may include an energy dissipation layer to decrease the kinetic energy of a buffer portion of the slurry that flows through the energy dissipation layer relative to the kinetic energy of a central portion of the slurry that flows through a central region of the pipe. This decrease in the kinetic energy of the buffer portion of the slurry may decrease abrasion of the pipe by the slurry.

### CROSS-REFERENCE TO RELATED APPLICATION

This application claims the priority benefit of U.S. Provisional Patent Application 61/641,065 filed 1 May 2012 entitled SYSTEMS AND METHODS FOR DECREASING ABRASIVE WEAR IN A PIPELINE THAT IS CONFIGURED TO TRANSFER A SLURRY, the entirety of which is incorporated by reference herein.

### FIELD OF DISCLOSURE

The present disclosure is directed generally to systems and methods for transferring a slurry within a pipeline, and more particularly to systems and methods that include an energy dissipation layer to decrease abrasive wear of the pipeline by the slurry.

### BACKGROUND OF THE DISCLOSURE

Slurries, which are mixtures of a liquid and solid particles, may be present and/or utilized in a variety of industrial processes. Often, it may be desirable to transfer and/or convey the slurry between a first location and a second location as part of the industrial process. This transfer may be accomplished in a variety of ways, such as through the use of conveyor belts, trucking equipment, and/or pipelines. Conveyor belts and/or trucking equipment may be inefficient at transferring a slurry due to the complicated nature of the required systems, loss of slurry material during transport, drying of the slurry during transport, wear of mechanical components, environmental/geographical constraints, and/or high fuel and/or energy costs.

Pipelines, while generally more efficient, often suffer from abrasive wear due to physical and/or chemical interactions between the inner surface of the pipeline and the slurry. This may result in high equipment and/or labor costs, as well as significant down time that may be associated with regular repair and/or replacement of the pipeline. These abrasive wear effects are especially pronounced when a pipeline is utilized to transfer a slurry that includes a high solids content, to transfer a slurry at a high flow rate, and/or to transfer a slurry under turbulent flow conditions.

As an illustrative, non-exclusive example, an oil sands mining operation may utilize a pipeline to transfer a slurry between a mine site and an ore processing facility, where the oil and/or bitumen that is present within the oil sands may be separated from the remaining components of the slurry. Under these conditions, the pipeline may serve as both a conveyance, which may transfer the slurry for several kilometers, as well as mixing vessel, which may provide for thorough mixing of the slurry components, and/or separation of the oil and/or bitumen that is present within the slurry from the solid particles, while the slurry flows from the mine site to the ore processing facility.

To affect both rapid transport of the slurry and effective mixing of the slurry components, the slurry may flow through the pipeline at a high average velocity, or flow rate, and/or under turbulent flow conditions. These high flow rates may cause rapid erosion of the pipeline, especially at the bottom surface, where gravitational forces may concentrate the solid particles within the slurry. This wear decreases the service life of the pipeline and increases the costs associated with transferring the slurry. Thus, there exists a need for improved pipelines and/or pipeline assemblies that may resist the abrasive wear that may be caused by the flow of a slurry therethrough.

### SUMMARY OF THE DISCLOSURE

Systems and methods for decreasing abrasive wear in a pipeline that is configured to transfer a slurry that includes a liquid and solid particles. The pipeline includes a pipe, which defines a pipeline conduit, and an energy dissipation layer that is within the pipeline conduit and through which a portion of the slurry flows. The systems and methods may include the use of the energy dissipation layer to decrease the kinetic energy of a buffer portion of the slurry that flows through the energy dissipation layer relative to the kinetic energy of a central portion of the slurry that flows through a central region of the pipe. This decrease in the kinetic energy of the buffer portion of the slurry may decrease abrasion of the pipe by the slurry.

In some embodiments, the energy dissipation layer may be configured to decrease the kinetic energy of the buffer portion of the slurry while providing for at least substantially unoccluded and/or unimpeded flow of the central portion of the slurry. In some embodiments, the energy dissipation layer may be configured to decrease the kinetic energy of the buffer portion of the slurry while providing for flow of the buffer portion therethrough.

In some embodiments, the energy dissipation layer may include a porous structure that is configured to absorb a portion of the kinetic energy from the buffer portion of the slurry. In some embodiments, the porous structure includes a high porosity. In some embodiments, an average pore throat diameter of the porous structure is significantly larger than an average diameter of the solid particles.

In some embodiments, the energy dissipation layer and the pipe may form a composite structure. In some embodiments, the energy dissipation layer and the pipe may form a monolithic structure.

### BRIEF DESCRIPTION OF THE DRAWINGS

FIG. 1 is a schematic representation of illustrative, non-exclusive examples of a slurry processing system that may utilize a pipeline according to the present disclosure to transfer a slurry.

FIG. 2 is a schematic longitudinal cross-sectional view of illustrative, non-exclusive examples of a pipeline that includes an energy dissipation layer according to the present disclosure.

FIG. 3 is a schematic transverse cross-sectional view of illustrative, non-exclusive examples of a pipeline that includes an energy dissipation layer according to the present disclosure.

FIG. 4 is a schematic longitudinal cross-sectional view of additional illustrative, non-exclusive examples of a pipeline according to the present disclosure that includes one or more intermediate layers between the pipe and the energy dissipation layer.

FIG. 5 is a schematic transverse cross-sectional view of pipelines that include various energy dissipation layers according to the present disclosure.

FIG. 6 is a schematic longitudinal cross-sectional view of illustrative, non-exclusive examples of a pipeline that includes a wire mesh energy dissipation layer according to the present disclosure.

FIG. 7 is a schematic longitudinal cross-sectional view of an illustrative, non-exclusive example of a pipeline that includes an energy dissipation layer according to the present disclosure in the form of a plurality of layers of chain link fencing.

FIG. 8 is a flowchart depicting methods according to the present disclosure of decreasing abrasive wear in a pipeline.

### DETAILED DESCRIPTION AND BEST MODE OF THE DISCLOSURE

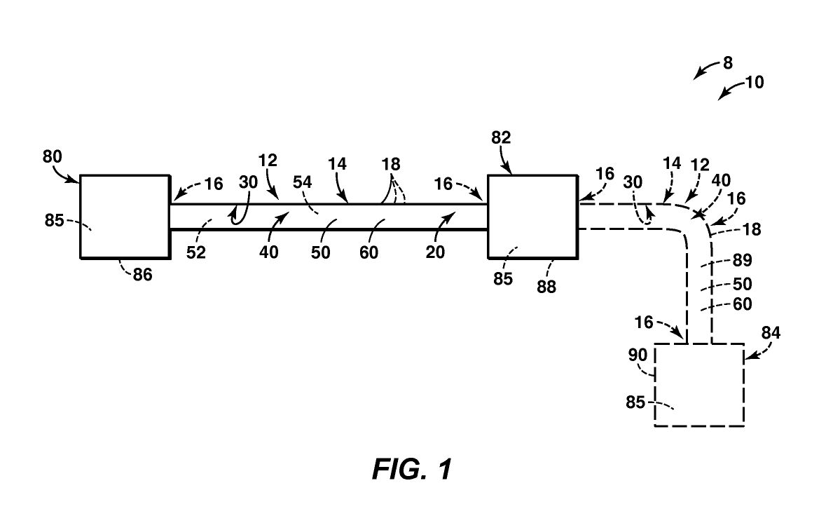

FIGS. 1-7 provide illustrative, non-exclusive examples of pipelines 12 according to the present disclosure, as well as slurry processing systems 10 and/or hydrocarbon processing systems 8 that may utilize the pipelines. Elements that serve a similar, or at least substantially similar, purpose are labeled with like numbers in each of FIGS. 1-7; and these elements may not be discussed in detail herein with reference to each of FIGS. 1-7. Similarly, all elements may not be labeled in each of FIGS. 1-7, but the reference numerals associated therewith may still be utilized herein for consistency. In general, elements that are likely to be included in a given embodiment are shown in solid lines, while elements that are optional are shown in dashed lines. However, elements that are shown in solid lines are not essential to all embodiments, and it is within the scope of the present disclosure that an element shown in solid lines may be omitted from a particular embodiment.

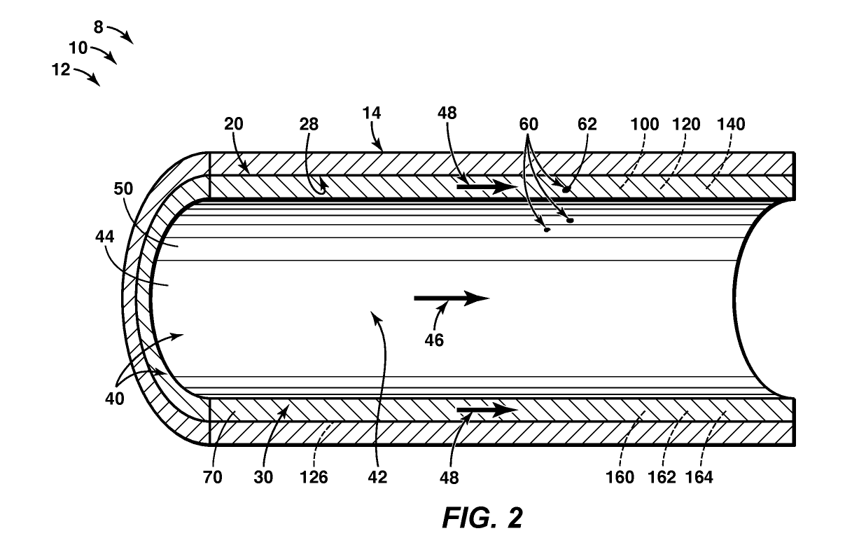

FIG. 1 is a schematic representation of illustrative, non-exclusive examples of a slurry processing system 10 that may utilize a pipeline 12 according to the present disclosure to transfer, or convey, a slurry 40 including a liquid 50 and solid particles 60 between a first location 80 and a second location 82, and/or between the second location and a third location 84. Pipeline 12 includes a pipe 14 that may be formed from one or more interconnected segments 18, as well as an energy dissipation layer 30, which is discussed in more detail herein with reference to FIGS. 2-7. Accordingly, pipe 14 may additionally or alternatively be referred to herein as a pipe assembly, and segments 18 may additionally or alternatively be referred to as pipe segments.

Pipeline 12 may be used in any suitable process where it may be desirable to transfer slurry 40 between two or more locations. As an illustrative, non-exclusive example, slurry processing system 10 may be and/or form a portion of a hydrocarbon processing system 8 that is configured to transfer and/or process a hydrocarbon 52. As another illustrative, non-exclusive example, when slurry processing system 10 forms a portion of hydrocarbon processing system 8, first location 80 may include and/or be a mine site 86, which also may be referred to herein as a hydrocarbon mine 86, that is configured to provide slurry 40 to pipeline 12; second location 82 may include and/or be a processing plant 88, which also may be referred to herein as an ore processing facility 88 and/or a hydrocarbon ore processing facility and which is configured to separate hydrocarbon 52 from the other components of slurry 40; and third location 84 may include and/or be a tailings disposal site 90, which also may be referred to herein as a tailings pond 90, which may be configured to dispose of, store, and/or otherwise process mine tailings 89 that may be generated by processing plant 88.

It is within the scope of the present disclosure that pipeline 12, first location 80, second location 82, and/or third location 84 may include, and/or be in communication with, any suitable process equipment 85 that may be configured to mine, produce, process, and/or transfer slurry 40. Illustrative, non-exclusive examples of process equipment 85 according to the present disclosure include any suitable pump, compressor, conveyor, auger, fluid conduit, valve, mixer, screen, filter, grinder, solid/liquid separation apparatus, liquid/gas separation apparatus, fluid injection system, chemical injection system, and/or slurry storage system.

Slurry processing system 10 may include one or more transition regions 16, within which a flow characteristic of slurry 40 changes. Illustrative, non-exclusive examples of transition regions 16 according to the present disclosure include entrance regions, in which slurry 40 enters pipeline 12; exit regions, in which slurry 40 exits pipeline 12; and/or bend regions, in which an average aggregate flow direction of slurry 40 changes.

Pipe 14, which also may be referred to herein as body 14, solid 14, and/or solid body 14, may include any suitable structure that is configured to define and/or form a pipeline conduit 20 that may hold, contain, surround, convey, and/or transfer slurry 40. As an illustrative, non-exclusive example, pipe 14 may include a metallic pipe and/or a cylindrical metallic pipe.

As discussed in more detail herein, slurry 40 may include liquid 50 and solid particles 60. Illustrative, non-exclusive examples of liquid 50 include water, bitumen, and/or a liquid hydrocarbon. Illustrative, non-exclusive examples of solid particles 60 include sand, clay, rock, hydrocarbon ore, and/or mine tailings 89.

Solid particles 60 may comprise any suitable portion, fraction, and/or percentage of slurry 40. As illustrative, non-exclusive examples, solid particles 60 may comprise at least 5, at least 10, at least 15, at least 20, at least 25, at least 30, at least 35, at least 40, at least 45, at least 50, or at least 55 volume percent of slurry 40. Additionally or alternatively, solid particles 60 may comprise less than 70, less than 65, less than 60, less than 55, less than 50, less than 45, or less than 40 volume percent of the slurry.

When slurry 40 includes hydrocarbon 52, hydrocarbon 52 may include at least one or more liquid hydrocarbons. In addition, hydrocarbon 52 may comprise any suitable proportion, fraction, and/or percentage of slurry 40. As illustrative, non-exclusive examples, hydrocarbon 52 may comprise at least 0.25, at least 0.5, at least 1, at least 2, at least 3, at least 5, at least 10, at least 15, at least 20, at least 25, at least 30, or at least 35 volume percent of the slurry. Additionally or alternatively, hydrocarbon 52 may comprise less than 50, less than 45, less than 40, less than 35, less than 30, less than 25, less than 20, less than 15, less than 10, or less than 5 volume percent of the slurry.

It is within the scope of the present disclosure that slurry 40 may include one or more additional components 54. As an illustrative, non-exclusive example, additional component 54 may include and/or be a separation-enhancing component. Illustrative, non-exclusive examples of separation-enhancing components according to the present disclosure include a caustic material, a caustic soda, sodium hydroxide, and/or naphthalic acid.

Slurry 40 may flow in and/or be conveyed through pipeline 12 under any suitable flow conditions. As an illustrative, non-exclusive example, at least a turbulent flow portion of slurry 40 may flow through pipeline 12 under turbulent flow conditions. Illustrative, non-exclusive examples of the turbulent flow portion of slurry 40 may include at least 30%, at least 40%, at least 50%, at least 60%, at least 70%, at least 80%, or least 90%, at least 95%, or at least 99% of a total volume of the slurry that is within pipeline 12. Additionally or alternatively, the turbulent flow portion of slurry 40 may include less than 99.9%, less than 99.5%, less than 99%, less than 97.5%, less than 95%, less than 90%, less than 85%, less than 80%, or less than 75% of the total volume of the slurry.

As another illustrative, non-exclusive example, slurry 40 may flow through pipeline 12 with any suitable average slurry flow rate and/or average slurry flow velocity. Illustrative, non-exclusive examples of average slurry flow velocities according to the present disclosure include average slurry flow velocities of at least 0.5, at least 1, at least 2, at least 3, at least 4, at least 5, at least 6, or at least 7 meters per second. Additionally or alternatively, the average slurry flow velocity may be less than 10, less than 7, less than 6, less than 5, less than 4, less than 3, less than 2, or less than 1 meters per second.

FIG. 2 is a schematic longitudinal cross-sectional view of illustrative, non-exclusive examples of pipeline 12 of FIG. 1. As shown in FIG. 2, pipeline 12 includes pipe 14, which includes inner surface 28 that defines, surrounds, and/or otherwise delineates pipeline conduit 20 through which slurry 40 flows. As also shown in FIG. 2, energy dissipation layer 30 may be proximal to inner surface 28 of pipe 14 and may bound, surround, define, and/or otherwise delineate at least a portion of a central region 42 of pipeline conduit 20 Inner surface 28 of pipe 14 may additionally or alternatively be referenced to herein as the inner circumference 28 of pipe 14.

As used herein, the term “proximal” may mean that the energy dissipation layer is close to, in mechanical contact with, attached to, and/or within a threshold separation distance of the inner surface of pipe 14. Illustrative, non-exclusive examples of threshold separation distances according to the present disclosure include threshold separation distances that are less than 10%, less than 7.5%, less than 5%, less than 4%, less than 3%, less than 2%, less than 1%, less than 0.5%, less than 0.1%, or less than 0.01% of an internal diameter of pipe 14.

Central region 42 of pipeline conduit 20, which also may be referred to herein as an axial region 42, a longitudinally extending region 42, and/or a central region that extends longitudinally from an entrance of the pipeline to an exit of the pipeline, may include any suitable portion of pipeline conduit 20 that is bounded, at least partially, by energy dissipation layer 30. As an illustrative, non-exclusive example, central region 42 may include the turbulent flow portion of slurry 40. As another illustrative, non-exclusive example, pipeline conduit 20 may include and/or contain energy dissipation layer 30, as well as a remainder of the pipeline conduit that does not contain the energy dissipation layer, and central region 42 may include a portion, a majority, and/or all of the remainder of the pipeline conduit.

Slurry 40 may include a central portion 44 that flows through central region 42 of pipeline conduit 20, as well as a buffer portion 70 that flows through energy dissipation layer 30. Central portion 44 of slurry 40 may flow through central region 42 of the pipeline conduit with an average velocity 46 and/or an average volumetric flow rate 46, which also may be referred to herein as an average central portion velocity 46 and/or an average central portion volumetric flow rate 46, that is different from, or greater than, an average velocity 48 and/or an average volumetric flow rate 48 of buffer portion 70, which also may be referred to herein as an average buffer portion velocity 48 and/or an average buffer portion volumetric flow rate 48. Thus, energy dissipation layer 30 may be configured to decrease the kinetic energy of buffer portion 70, while providing for unoccluded, or at least substantially unoccluded or unimpeded, flow of central portion 44 of slurry 40 through central region 42 of pipeline conduit 12.

As an illustrative, non-exclusive example, energy dissipation layer 30 may be configured to decrease an average velocity of buffer portion 70, an average velocity of solid particles 60 that may be present within buffer portion 70, the average volumetric flow rate 48 of buffer portion 70, and/or turbulence within the flow of buffer portion 70 when compared to central portion 44. As another illustrative, non-exclusive example, energy dissipation layer 30 may be configured to decrease the kinetic energy of the buffer portion while still providing for flow of the buffer portion through at least portions, if not all, of the energy dissipation layer. This may include decreasing the kinetic energy of the buffer portion without blocking, occluding, and/or stopping the flow of the buffer portion therethrough and/or without trapping a significant fraction of the buffer portion within the energy dissipation layer. For example, energy dissipation layer 30 may be configured to slow or otherwise decrease the kinetic energy of buffer portion 70 of the slurry while still permitting the buffer portion to flow through the energy dissipation layer and thus without trapping or retaining the buffer portion of the slurry (including the solid particles thereof) in the energy dissipation layer. As yet another illustrative, non-exclusive example, energy dissipation layer 30 may be configured to decrease a rate at which slurry 40 erodes pipe 14 and/or inner surface 28 thereof. This may include decreasing the erosion rate without substantially decreasing average velocity 46 and/or average volumetric flow rate 46 of central portion 44.

It is within the scope of the present disclosure that energy dissipation layer 30 may include and/or be a compliant and/or resilient structure. When the energy dissipation layer includes such a compliant and/or resilient structure, the energy dissipation layer may be configured to bend, flex, and/or otherwise resiliently and/or reversibly deform responsive to mechanical and/or fluid contact between the energy dissipation layer and the slurry and/or responsive to flow of the slurry therepast.

It is also within the scope of the present disclosure that energy dissipation layer 30 may be, include, and/or be referred to as a means for reducing average velocity 48 and/or average volumetric flow rate 48 of buffer portion 70. As an illustrative, non-exclusive example, the means for reducing may be configured to decrease average velocity 48 and/or average volumetric flow rate 48 relative to an average velocity and/or an average volumetric flow rate through a similar pipeline that includes a similar pipeline conduit and/or a similar pipe but does not include the means for reducing.

Energy dissipation layer 30 may include and/or be any suitable material and/or structure that is configured to create buffer portion 70 and/or to decrease the kinetic energy thereof. As an illustrative, non-exclusive example, the energy dissipation layer may include a plurality of flow obstructions 160. As discussed in more detail herein, the plurality of flow obstructions may be configured to create buffer portion 70 and/or to decrease the kinetic energy thereof without trapping, blocking, stopping, and/or occluding flow of the buffer portion through (at least a portion, if not a majority portion, or even all or substantially all of) the energy dissipation layer. Illustrative, non-exclusive examples of flow obstructions 160 according to the present disclosure include any suitable array of extruded (or otherwise formed) honeycomb or other geometric tubes; porous and/or hollow-faced lattices; hollow-faced, non-right-angle cuboids; a plurality of radially aligned spikes; a plurality of interconnected, radially aligned spikes; a plurality of wires; a network of intertwined wires; a network of unconnected but intertwined wires; wire mesh; wire fencing; chain link fencing; expanded metal; and/or wire cloth.

As another illustrative, non-exclusive example, energy dissipation layer 30 and/or flow obstructions 160 thereof may include and/or be referred to as a porous structure 162 that may include any suitable porosity. Illustrative, non-exclusive examples of porous structures according to the present disclosure include any suitable extruded structure, honeycomb, foam, porous foam, open-cell foam, ceramic, porous ceramic, sintered structure, periodic structure, and/or repeating structure. Illustrative, non-exclusive examples of porosities according to the present disclosure include porosities of at least 50%, at least 60%, at least 70%, at least 75%, at least 80%, at least 85%, at least 90%, at least 95%, at least 99%, or at least 99.9%, as well as porosities of less than 100%, less than 99.9%, less than 90%, less than 98%, less than 97%, less than 96%, or less than 95%.

When energy dissipation layer 30 includes porous structure 162, the porous structure may include a plurality of pores 164. It is within the scope of the present disclosure that pores 164 may include interconnected pores, which may be in fluid communication with one another, and/or isolated pores, which may not be in fluid communication with one another; and that the isolated pores may comprise any suitable portion, or fraction, of the plurality of pores. As illustrative, non-exclusive examples, the isolated pores may comprise less than 25%, less than 20%, less than 15%, less than 10%, less than 5%, less than 1%, or none of the plurality of pores. Likewise, the interconnected pores may comprise at least 50%, at least 75% at least 80%, at least 85%, at least 90%, at least 95%, at least 99%, and all of the plurality of pores.

The plurality of pores 164 of porous structure 162, when present, may include a plurality of pore throats, or openings, therebetween. The plurality of pore throats may define an average pore throat diameter, which also may be referred to herein as an average equivalent pore throat diameter. When the plurality of pore throats include circular, or at least substantially circular, pore throats, the average pore throat diameter may include an average diameter of the pore throats. Additionally or alternatively, and when the pore throats include non-circular pore throats, the average equivalent pore throat diameter may include the diameter of a circle that has the same area as an average pore throat area.

Similarly, solid particles 60 of slurry 40 may define an average particle diameter and/or an average equivalent particle diameter. When the solid particles include spherical, or at least substantially spherical, solid particles, the average particle diameter may be determined based upon the average diameter of the solid particles. Additionally or alternatively, and when the solid particles include non-spherical solid particles, the average equivalent particle diameter may be determined based upon the diameter of a circle that the same area as an average representative cross-sectional area of the plurality of particles. An illustrative, non-exclusive example of the average representative cross-sectional area of the plurality of particles includes an average maximum cross-sectional area of each of the plurality of particles.

It is within the scope of the present disclosure that the average pore throat diameter may be selected, chosen, defined, and/or fabricated based, at least in part, on the average solid particle diameter. As an illustrative, non-exclusive example, the average pore throat diameter may be selected to be greater than the average solid particle diameter. This may include average pore throat diameters that are at least 2, at least 5, at least 10, at least 20, at least 25, at least 50, at least 75, at least 100, at least 150, at least 200, at least 250, or at least 500 times larger than the average solid particle diameter. Additionally or alternatively, the average pore throat diameter may be selected to be greater than 50, greater than 250, greater than 1,000, greater than 2,000, greater than 5,000, or greater than 20,000 micrometers.

As used herein, the term “porous structure” may include any suitable structure for energy dissipation layer 30 that may include and/or define both solid regions and open, or void, regions. Each of the illustrative, non-exclusive examples of energy dissipation layers 30 that are disclosed herein also may be referred to herein as porous structure and/or may be considered to include a porosity.

As used herein, the term “porosity” may refer to a ratio of a volume of the open, or void, regions of the porous structure to the total volume of the porous structure. As an illustrative, non-exclusive example, the porosity of any suitable energy dissipation layer 30, including the energy dissipation layers that are discussed in more detail herein, may be defined as a ratio of the volume of the void space within the energy dissipation layer that may provide for flow of buffer portion 70 therethrough to the total volume of the energy dissipation layer. In the illustrative, non-exclusive example of FIG. 2, this porosity may include and/or be approximated as a ratio of the volume of buffer portion 70 that is present within energy dissipation layer 30 to the overall volume of the annular region that is defined by the energy dissipation layer.

Energy dissipation layer 30 may be present within any suitable portion, fraction, and/or percentage of pipeline 12 and/or pipe 14 thereof. As an illustrative, non-exclusive example, the energy dissipation layer may extend around a portion of an internal circumference (or inner surface) 28 of pipe 14. It is within the scope of the present disclosure that the portion of the internal circumference may include a bottom surface of the pipeline conduit. Additionally or alternatively, it is also within the scope of the present disclosure that the portion of the circumference may include a majority, at least 50%, at least 60%, at least 70%, at least 75%, at least 80%, at least 85%, at least 90%, at least 95%, at least 99%, or the entire internal circumference of the pipe. When the energy dissipation layer extends around the entire internal circumference of the pipe, it is within the scope of the present disclosure that the energy dissipation layer may be uniform, or at least substantially uniform, around the internal circumference of the pipe.

As another illustrative, non-exclusive example, the energy dissipation layer may extend along any suitable portion, fraction, and/or percentage of a length of pipeline 12 and/or pipe 14 thereof. As illustrative, non-exclusive examples, the energy dissipation layer may extend along a majority, at least 50%, at least 60%, at least 70%, at least 75%, at least 80%, at least 85%, at least 90%, at least 95%, at least 99%, or an entire length of pipeline 12. Illustrative, non-exclusive examples of lengths of pipeline 12 and/or pipe 14 according to the present disclosure include lengths of at least 0.1 kilometers, at least 0.5 kilometers, at least 1 kilometer, at least 2 kilometers, at least 3 kilometers, at least 4 kilometers, at least 5 kilometers, at least 7.5 kilometers, at least 10 kilometers, at least 15 kilometers, at least 25 kilometers, or at least 50 kilometers.

It is within the scope of the present disclosure that energy dissipation layer 30 may be uniform, the same, or at least substantially the same, throughout the length of pipeline 12. However, it is also within the scope of the present disclosure that one or more transition regions 16 (as shown in FIG. 1) may include a transition region energy dissipation layer that is different from a remainder of the energy dissipation layer that is present within pipeline 12. As an illustrative, non-exclusive example, the transition region energy dissipation layer may include a different thickness, a greater thickness, a different material of construction, and/or a different porosity than the remainder of the energy dissipation layer. Illustrative, non-exclusive examples of energy dissipation layer thicknesses, materials of construction, and porosities are discussed in more detail herein.

Energy dissipation layer 30 may be incorporated into pipeline 12 in any suitable manner. As an illustrative, non-exclusive example, pipe 14 and energy dissipation layer 30 may form a composite structure. When pipe 14 and energy dissipation layer 30 form a composite structure, it is within the scope of the present disclosure that energy dissipation layer 30 may be formed within the pipe and/or applied to inner surface 28 of the pipe, with such an energy dissipation layer 30 being indicated generally at 100. As an illustrative, non-exclusive example, such an energy dissipation layer 100 may be coated and/or sprayed onto the inner surface of the pipe. Illustrative, non-exclusive examples of energy dissipation layers 100 according to the present disclosure include any suitable porous layer, foam, porous foam, coating, abrasion-resistant layer, and/or corrosion-resistant layer.

Additionally or alternatively, and when pipe 14 and energy dissipation layer 30 form a composite structure, it is within the scope of the present disclosure that energy dissipation layer 30 may be fabricated separately from the pipe and placed, slid, or otherwise inserted within the pipeline conduit during assembly of the pipeline, as indicated generally at 120. Illustrative, non-exclusive examples of such energy dissipation layers 120 according to the present disclosure include any suitable foam, porous foam, ceramic material, porous ceramic, expanded metal, wire cloth, metallic material, polymeric material, high manganese steel structure, composite material, extruded structure, honeycomb, sintered structure, and/or periodic, or repeating, structure.

It is within the scope of the present disclosure that energy dissipation layer 120 may not be affixed, or attached, to the pipe and/or to inner surface 28 thereof. Additionally or alternatively, it is also within the scope of the present disclosure that energy dissipation layer 120 may be operatively attached to inner surface 28 using any suitable mechanism and/or attachment structure 126, illustrative, non-exclusive examples of which include an adhesive, an adhesive bond, an epoxy, a weld, a braze, a friction fit, and/or a fastener.

When energy dissipation layer 30 is separately formed from pipe 14, such as energy dissipation layer 100 and/or energy dissipation layer 120, it is within the scope of the present disclosure that an outer diameter of energy dissipation layer 30 may be less than or equal to an inner diameter of pipe 14. As an illustrative, non-exclusive example, the outer diameter of energy dissipation layer 30 may be within 10%, 7.5%, 5%, 2.5%, or 1% of the inner diameter of pipe 14.

It is also within the scope of the present disclosure that energy dissipation layer 30 and pipe 14 may include, form, and/or be a monolithic structure wherein the energy dissipation layer is formed from the pipe, as indicated generally at 140. When the energy dissipation layer and the pipe form a monolithic structure, energy dissipation layer 30 may be formed within pipe 14 in any suitable manner and/or using any suitable process, illustrative, non-exclusive examples of which include cutting, etching, and/or machining to remove material from pipe 14, to remove material from inner surface 28 of pipe 14, and/or to form inner surface 28 of pipe 14.

Buffer portion 70 of slurry 40 may include any suitable fraction, or percentage, of the slurry. As an illustrative, non-exclusive example, pipeline 12 may include a total volume of slurry therein, and buffer portion 70 may include less than 25%, less than 20%, less than 15%, less than 12.5%, less than 10%, less than 7.5%, less than 5%, or less than 2% of the total volume of slurry. Additionally or alternatively, the buffer portion may include at least 1%, at least 2.5%, at least 5%, at least 7.5%, or at least 10% of the total volume of the slurry.

As discussed in more detail herein, energy dissipation layer 30 may be configured to decrease buffer portion average velocity and/or buffer portion average volumetric flow rate 48 relative to central portion average velocity and/or central portion average volumetric flow rate 46, such as by a reduction fraction. As used herein, a reduction fraction refers to a percentage of the central portion value. For example, reducing the central portion average velocity by a reduction fraction of 0.8 will result in a buffer portion average velocity that is 80% of the central portion average velocity. Illustrative, non-exclusive examples of reduction fractions according to the present disclosure include reduction fractions that are at least 0.2, at least 0.3, at least 0.4, at least 0.5, at least 0.6, at least 0.7, at least 0.75, at least 0.8, at least 0.85, at least 0.9, at least 0.92, at least 0.94, at least 0.96, at least 0.98, or at least 0.99, as well as reduction fractions that are less than 0.995, less than 0.99, less than 0.95, less than 0.9, less than 0.8, less than 0.7, less than 0.6, less than 0.5, or less than 0.4. Additionally or alternatively, the buffer portion average velocity and/or the buffer portion average volumetric flow rate may be less than 1%, less than 5%, less than 10%, less than 20%, less than 30%, less than 40%, less than 50%, less than 60%, less than 70%, less than 80%, less than 90%, or less than 95%, and/or at least 0.1%, at least 1%, at least 5%, at least 10%, at least 20%, at least 30%, at least 40%, at least 50%, at least 60%, or at least 70% of an average overall velocity and/or an average overall volumetric flow rate of the slurry within the pipeline.

As discussed in more detail herein, slurry 40 may include solid particles 60. A portion of the solid particles may be present within central portion 44 of the slurry, and a portion of the solid particles may be present within buffer portion 70 of the slurry. Buffer portion 70, which as discussed herein is slowed as it flows through energy dissipation layer 30, may be configured to reduce the kinetic energy of an impinging solid particle 62 that enters the buffer portion from central region 42 of pipeline conduit 20 and/or from central portion 44 of slurry 40. As an illustrative, non-exclusive example, the buffer portion may be configured to absorb a portion of the kinetic energy of the impinging solid particle. As another illustrative, non-exclusive example, the buffer portion may be configured to absorb the portion of the kinetic energy of the impinging solid particle without substantial, or any, wear to the pipe and/or to the energy dissipation layer.

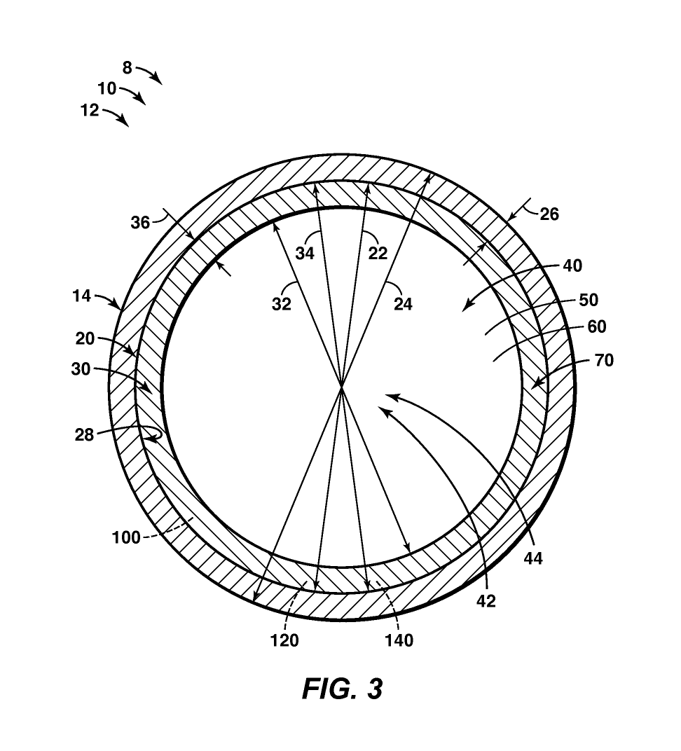

FIG. 3 is a schematic transverse cross-sectional view of illustrative, non-exclusive examples of pipeline 12 of FIGS. 1 and 2. As shown in FIG. 3, pipe 14 may include an inner, or internal, diameter 22 and an outer diameter 24 that may define a pipe wall thickness 26, which also may be referred to herein as pipe radial thickness 26. Similarly, energy dissipation layer 30 may include an inner, or internal, diameter 32 and an outer diameter 34 that may define an energy dissipation layer thickness 36, which also may be referred to herein as energy dissipation layer wall thickness 36 and/or energy dissipation layer radial thickness 36. When pipe 14 and/or energy dissipation layer 30 includes a circular, or annular, cross-sectional shape, the above-discussed diameters 22, 24, 32, and 34 may be utilized to define and/or describe the cross-sectional shape. However, it is within the scope of the present disclosure that pipe 14 and/or energy dissipation layer 30 may include any suitable cross-sectional shape, including non-circular and/or non-annular cross-sectional shapes. When pipe 14 and/or energy dissipation layer 30 includes a non-circular and/or non-annular cross-sectional shape, inner diameter 22 also may be referred to herein as inner characteristic dimension 22, outer diameter 24 also may be referred to herein as outer characteristic dimension 24, inner diameter 32 also may be referred to herein as inner characteristic dimension 32, and/or outer diameter 34 also may be referred to herein as outer characteristic dimension 34.

Pipe 14 may include any suitable inner diameter 22. As illustrative, non-exclusive examples the inner diameter of pipe 14 may be at least 0.25 meters, at least 0.5 meters, at least 0.75 meters, or at least 1 meter. Additionally or alternatively, the inner diameter of pipe 14 may be less than 2 meters, less than 1.75 meters, less than 1.5 meters, less than 1.25 meters, or less than 1 meter.

As shown in FIG. 3, energy dissipation layer 30 may be concentric with, or at least substantially concentric with, at least a portion of pipe 14. Additionally or alternatively, a hollow region of energy dissipation layer 30 that defines central region 42 of pipeline conduit 20 may be concentric with pipe 14 and/or with energy dissipation layer 30. However, it is also within the scope of the present disclosure that energy dissipation layer 30 and/or central region 42 may not be concentric with one another and/or with pipe 14 and/or may not include a circular and/or annular cross-sectional shape.

Energy dissipation layer thickness 36 may include any suitable thickness that may produce buffer portion 70 and also provide for flow of central portion 44 through central region 42 of the pipeline conduit. Illustrative, non-exclusive examples of energy dissipation layer thicknesses according to the present disclosure include energy dissipation layer thicknesses of less than 500%, less than 200%, less than 100%, less than 75%, or less than 50% of pipe wall thickness 26. Additionally or alternatively, the energy dissipation layer thickness may be greater than 10%, greater than 25%, greater than 50%, greater than 75%, greater than 100%, or greater than 200% of the pipe wall thickness.

As another illustrative, non-exclusive example, the energy dissipation layer thickness may be selected to be less than 20%, less than 10%, less than 7.5%, less than 5%, or less than 2.5% of inner diameter 22 and/or outer diameter 24 of pipe 14. Additionally or alternatively, the energy dissipation layer thickness may be determined based, at least in part, on the average solid particle diameter. As illustrative, non-exclusive examples, the energy dissipation layer thickness may be at least 5, at least 10, at least 25, or at least 50 times larger than the average solid particle diameter. As another illustrative, non-exclusive example, the energy dissipation layer thickness may be less than 100, less than 50, less than 20, or less than 10 times the average solid particle diameter.

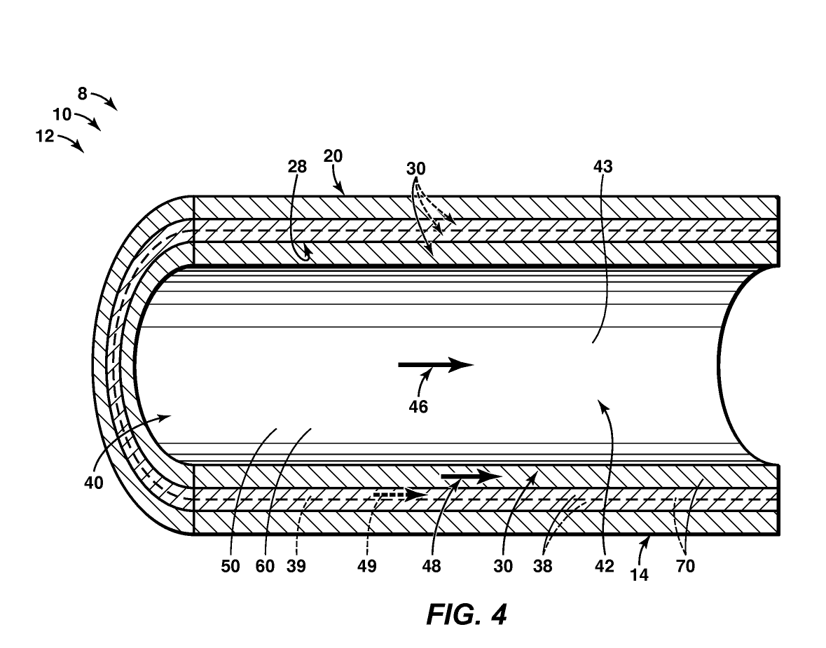

FIG. 4 is a schematic longitudinal cross-sectional view of additional illustrative, non-exclusive examples of pipeline 12 according to the present disclosure. As depicted in FIG. 4, a pipeline 12 according to the present disclosure may include one or more optional intermediate layers 38 between inner surface 28 of pipe 14 and energy dissipation layer 30. When present, intermediate layer 38 may include any suitable structure. As illustrative, non-exclusive examples, intermediate layer 38 may include any suitable energy dissipation layer, including the illustrative, non-exclusive examples of energy dissipation layers 30 that are discussed in more detail herein, porous layer, abrasion-resistant layer, corrosion-resistant layer, adhesive layer, coating, and/or void space. When intermediate layer 38 includes a porous layer, it is within the scope of the present disclosure that the intermediate layer may include a different porosity than the porosity of energy dissipation layer 30. Illustrative, non-exclusive examples of intermediate layer porosities according to the present disclosure include porosities that are less than the porosity of the energy dissipation layer, such as porosities of less than 40%, less than 35%, less than 30%, less than 25%, less than 20%, less than 15%, less than 10%, less than 5%, or less than 1%, as well as porosities of substantially zero. When intermediate layer 38 includes a porous layer, an intermediate portion 39 of slurry 40 may be configured to flow though the intermediate layer with an average velocity, or volumetric flow rate, 49 that may be greater than, equal to, or less than buffer portion average velocity, or volumetric flow rate, 48.

It is within the scope of the present disclosure that intermediate layer 38 may be configured to perform any suitable function. As illustrative, non-exclusive examples, the intermediate layer may be configured to further decrease abrasive wear of pipe 14 by slurry 40, provide a transition and/or adhesion layer between inner surface 28 and energy dissipation layer 30, and/or function as an additional buffer portion 70 that may further protect pipe 14 from slurry 40.

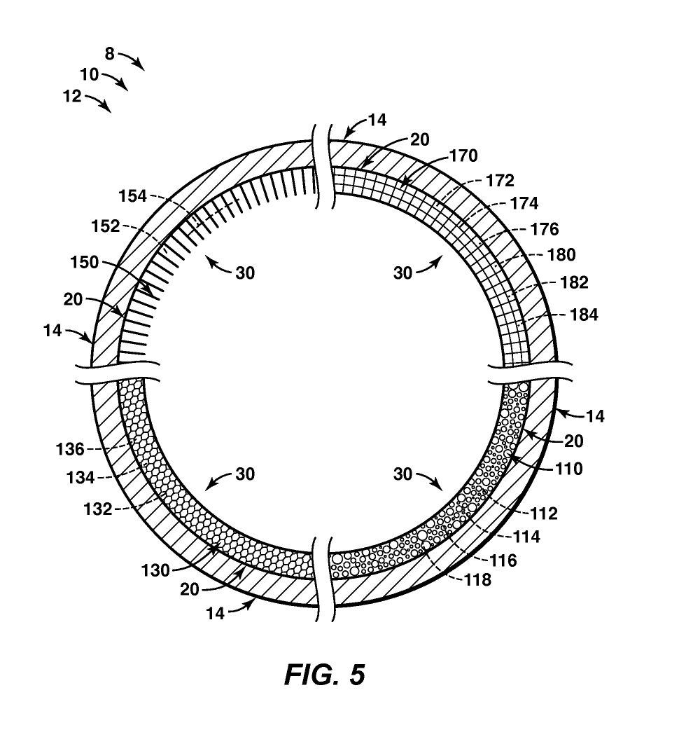

FIG. 5 is a schematic transverse cross-sectional view of pipelines 12 that include various illustrative, non-exclusive examples of energy dissipation layers 30 according to the present disclosure. FIG. 5 schematically illustrates that energy dissipation layers 30 according to the present disclosure may include any suitable expanded structure 110, extruded structure 130, radially extending array 150, and/or lattice 170.

As an illustrative, non-exclusive example, and as shown in FIG. 5 at 112, energy dissipation layer 30 may include expanded structure 110 in the form of a foam. Additional illustrative, non-exclusive examples of expanded structures 110 according to the present disclosure include any suitable porous foam 114, open cell foam 116, and/or expanded metal 118.

As another illustrative, non-exclusive example, and as shown in FIG. 5 at 132, energy dissipation layer 30 may include extruded structure 130 in the form of a honeycomb. Additional illustrative, non-exclusive examples of extruded structures 130 according to the present disclosure include any suitable geometric tube 134 and/or periodic, or repeating, structure 136.

As yet another illustrative, non-exclusive example, and as shown in FIG. 5 at 152, energy dissipation layer 30 may include radially extending array 150 in the form of an array of radially extending spikes 152. It is within the scope of the present disclosure that the array of radially extending spikes may include discrete spikes 152 and/or interconnected spikes 154.

As another illustrative, non-exclusive example, and as shown in FIG. 5 at 172, energy dissipation layer 30 may include lattice 170 in the form of a plurality of wires. Additional illustrative, non-exclusive examples of a lattice 170 according to the present disclosure include a network of intertwined wires 174; wire fencing 176; wire mesh 178; wire cloth 180; hollow-face, non-right-angle cuboids 182; and/or chain link fencing 184.

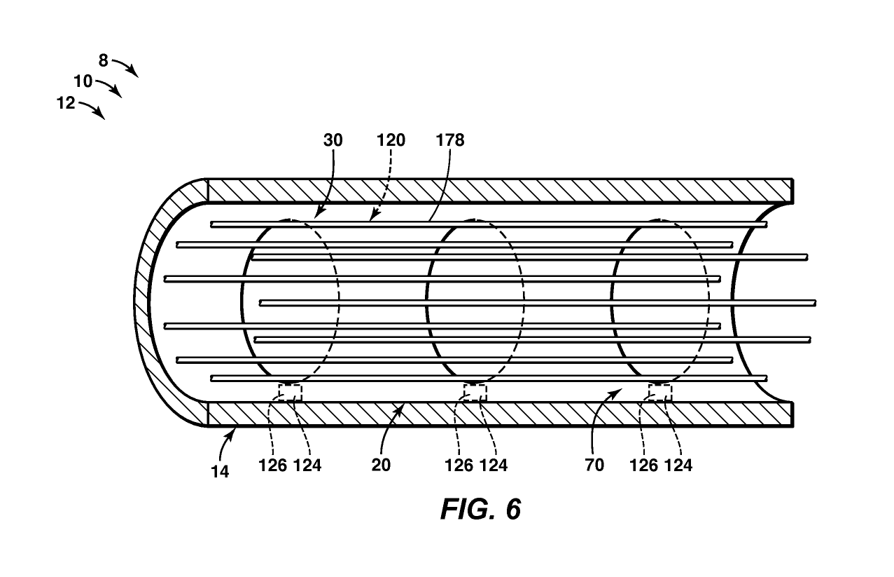

FIG. 6 is a less schematic longitudinal cross-sectional view of illustrative, non-exclusive examples of a pipeline 12 that includes an energy dissipation layer 30 that includes and/or is formed from a wire mesh 178. Such an energy dissipation layer 30 may be inserted into pipeline conduit 20, as indicated generally at 120. As shown in FIG. 6, the wire mesh energy dissipation layer may comprise a cylindrical structure that may define inner diameter 32 of the energy dissipation layer and/or central region 42 of pipeline conduit 20 (as shown in FIG. 3) while providing for flow of buffer portion 70 therethrough.

As discussed in more detail herein, energy dissipation layers 30 according to the present disclosure may be located within but not affixed to pipe 14. When the energy dissipation layer is not affixed to pipe 14, one or more optional standoffs 124, which may be operatively attached to the energy dissipation layer and/or to the pipe, may serve to locate the energy dissipation layer within the pipe. In some embodiments, the shape and/or orientation of pipe 14 may serve to locate and/or retain the energy dissipation layer within the pipe. Additionally or alternatively, and as also discussed in more detail herein, the energy dissipation layer may be operatively attached to pipe 14 and/or to inner surface 28 thereof using any suitable attachment structure 126, illustrative, non-exclusive examples of which are discussed in more detail herein.

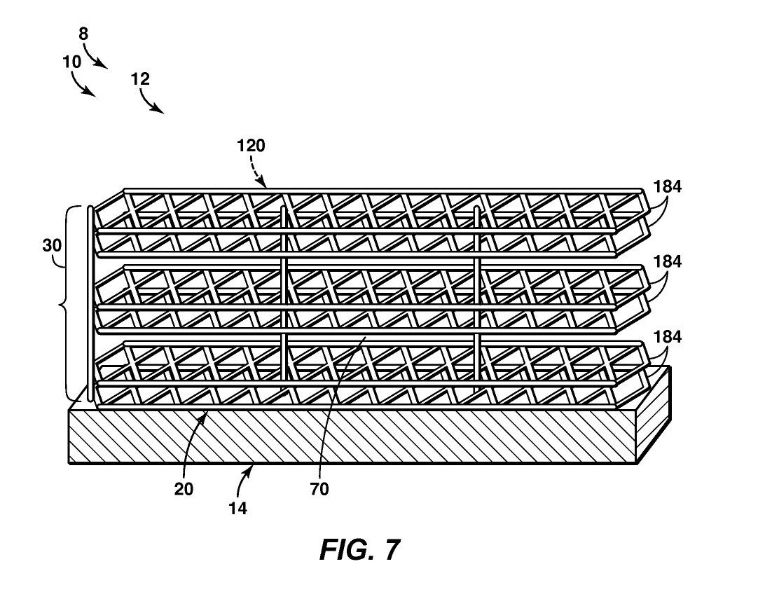

FIG. 7 is another less schematic longitudinal cross-sectional view of an illustrative, non-exclusive example of a portion of pipeline 12 that includes an energy dissipation layer 30 according to the present disclosure that includes and/or is formed of one or more of layers of chain link fencing 184. While six layers of chain link fencing 184 are shown in FIG. 7, it is within the scope of the present disclosure that any suitable number of layers may be utilized to form energy dissipation layer 30 and/or that one or more of the individual layers may include another energy dissipation layer material and/or structure, illustrative, non-exclusive examples of which are discussed in more detail herein. Similar to the wire mesh energy dissipation layer of FIG. 6, the energy dissipation layer of FIG. 7 may comprise a cylindrical, or annular, structure that may, as shown in FIG. 3, define inner diameter 32 of the energy dissipation layer and/or central region 42 of pipeline conduit 20 while providing for flow of buffer portion 70 therethrough.

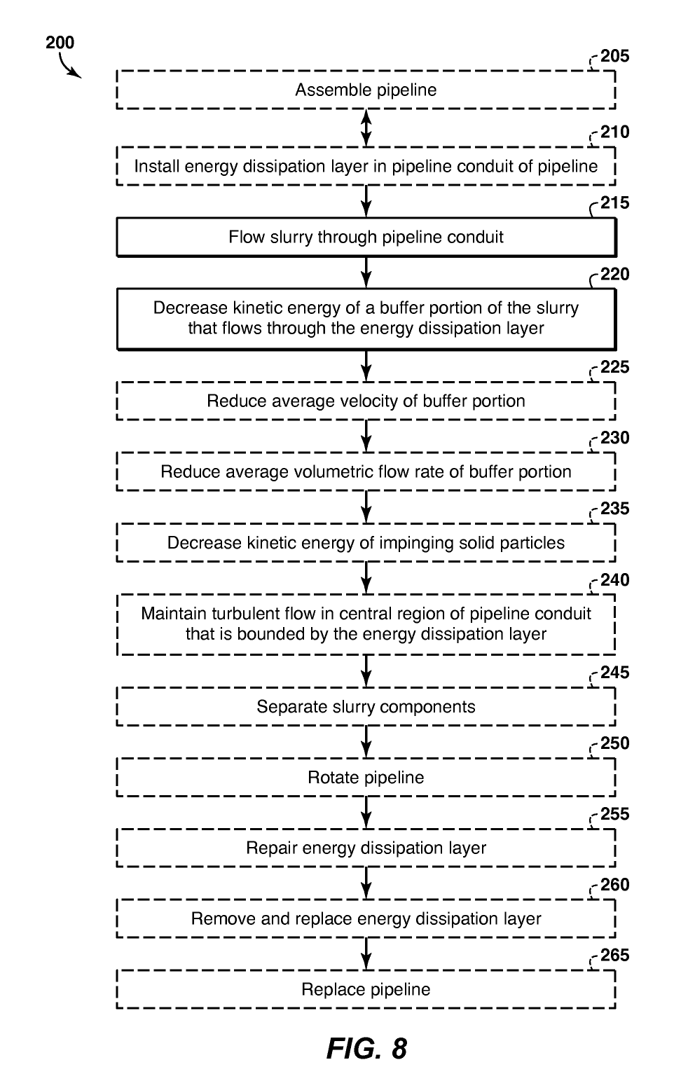

FIG. 8 is a flowchart depicting methods 200 of decreasing abrasive wear in a pipeline using an energy dissipation layer according to the present disclosure. Methods 200 may include assembling the pipeline at 205 and installing an energy dissipation layer within a pipeline conduit of the pipeline, such as in a pipe thereof, at 210. As discussed in more detail herein, and as graphically indicated with a double-headed arrow in FIG. 8, it is within the scope of the present disclosure that the energy dissipation layer may be installed within the pipeline, or at least a pipe segment thereof, prior to or after the assembling of the pipeline. The methods further include flowing a slurry through the pipeline conduit at 215 and decreasing the kinetic energy of a buffer portion of the slurry that flows through the energy dissipation layer at 220. The method also may include reducing an average velocity of the buffer portion at 225, reducing an average volumetric flow rate of the buffer portion at 230, decreasing kinetic energy of impinging solid particles that enter the buffer portion at 235, and/or maintaining turbulent flow in a central region of the pipeline conduit that is bounded by the energy dissipation layer at 240. The methods further may, but are not required to, include separating two or more components of the slurry at 245, rotating the pipeline at 250, repairing the energy dissipation layer at 255, removing and replacing the energy dissipation layer at 260, and/or replacing the pipeline at 265.

Assembling the pipeline at 205 may include constructing the pipeline, moving one or more components of the pipeline to a site where the pipeline will be constructed, and/or attaching a plurality of pipe segments together to form the pipe. Installing the energy dissipation layer in the pipeline conduit at 210 may include inserting and/or sliding the energy dissipation layer into the pipeline conduit and/or operatively attaching the energy dissipation layer to the pipe to form a composite structure, illustrative, non-exclusive examples of which are discussed in more detail herein. Additionally or alternatively, installing the energy dissipation layer in the pipeline conduit at 210 also may include forming the energy dissipation layer within the pipeline conduit to form the composite structure, illustrative, non-exclusive examples of which are discussed in more detail herein. Additionally or alternatively, installing the energy dissipation layer in the pipeline may include forming at least a portion of the energy dissipation layer from the pipe to form a monolithic structure that includes the pipe and the energy dissipation layer. Illustrative, non-exclusive examples of such monolithic structures are discussed in more detail herein.

Flowing the slurry through the pipeline conduit at 215 may include the use of any suitable structure to generate a motive force and provide for flow of the slurry through the pipeline. As illustrative, non-exclusive examples, this may include the use of any suitable pump, compressor, auger, conveyor, and/or gravitational force to develop pressure within the slurry.

Decreasing the kinetic energy of the buffer portion of the slurry at 220 may include decreasing the kinetic energy of the buffer portion with the energy dissipation layer. This may include impeding a flow of a portion of the slurry through the energy dissipation layer and/or absorbing a portion of the kinetic energy of the slurry with the energy dissipation layer to produce the buffer portion, while maintaining a flow of the buffer portion through the energy dissipation layer. The decreasing may include decreasing the kinetic energy of the buffer portion relative to the kinetic energy of a central portion of the slurry that flows through a central region of the pipeline and/or a pipeline conduit thereof. Additionally or alternatively, the decreasing may include decreasing the kinetic energy of the buffer portion of the slurry relative to the kinetic energy of a similar portion of a similar slurry that flows through a similar pipeline that does not include the energy dissipation layer.

Decreasing the kinetic energy of the buffer portion also may include reducing the average velocity of the buffer portion at 225 and/or reducing the average volumetric flow rate of the buffer portion at 230. This may include reducing the average velocity and/or the average volumetric flow rate by at least 50%, at least 60%, at least 70%, at least 75%, at least 80%, at least 90%, at least 95%, or at least 99%, and/or reducing the average velocity and/or the average volumetric flow rate by less than 99.5%, less than 99%, less than 98%, less than 90%, or less than 80%, less than 70%, or less than 60%. It is within the scope of the present disclosure that the reducing may be relative to the velocity and/or the volumetric flow rate of the central portion of the slurry. Additionally or alternatively, it is also within the scope of the present disclosure that the reducing may be relative to the velocity and/or the volumetric flow rate that would exist in the region that is defined by the energy dissipation layer if the energy dissipation layer was not present within the pipeline.

Reducing the kinetic energy of impinging solid particles that enter the buffer portion from the central portion of the slurry and/or from the central region of the pipeline conduit at 235 may include absorbing a portion of the kinetic energy of the impinging solid particles with the buffer portion of the slurry and/or with the energy dissipation layer. As an illustrative, non-exclusive example, a portion of the liquid and/or one or more solid particles that are present within the buffer portion of the slurry may absorb the portion of the kinetic energy from the impinging solid particles. As another illustrative, non-exclusive example, the energy dissipation layer may absorb a portion of the kinetic energy, such as by deformation of the energy dissipation layer by the impinging solid particles and/or abrasion of the energy dissipation layer by the impinging solid particles.

Maintaining turbulent flow in the central region of the pipeline conduit that is bounded by the energy dissipation layer at 240 may include maintaining turbulent flow within a turbulent flow portion of the slurry As illustrative, non-exclusive examples, the turbulent flow portion of the slurry may include at least 30%, at least 40%, at least 50%, at least 60%, at least 70%, at least 75%, at least 80%, at least 90%, at least 95%, or at least 99% of a total volume of the slurry that is within the pipeline. Additionally or alternatively, the turbulent flow portion of the slurry may include less than 99.9%, less than 99.5%, less than 99%, less than 97.5%, less than 95%, less than 90%, less than 85%, less than 80%, or less than 75% of the total volume of the slurry that is within the pipeline.

Maintaining turbulent flow also may include maintaining a Reynolds Number that is greater than a threshold Reynolds Number within the turbulent flow portion of the slurry. Illustrative, non-exclusive examples of threshold Reynolds Numbers according to the present disclosure include Reynolds Numbers that are greater than 2,000, greater than 2,100, greater than 2,300, greater than 2,500, greater than 3,000, or greater than 5,000.

Separating slurry components at 245 may include separating at least a first slurry component from at least a second slurry component. As an illustrative, non-exclusive example, and when the slurry includes a hydrocarbon, such as bitumen, the hydrocarbon may be bound to, and/or present within, a matrix of sand, or other solid, particles at an entrance to the pipeline. Under these conditions, flowing the slurry through the pipeline may include mixing the hydrocarbon and sand with a liquid component of the slurry to dissolve the hydrocarbon within the liquid component and/or to displace the hydrocarbon from the matrix of sand particles. It is within the scope of the present disclosure that the separation may include the addition of one or more separation-enhancing components, illustrative, non-exclusive examples of which are discussed in more detail herein, to the slurry to increase and/or improve the separating.

Rotating the pipeline at 250 may include periodically detaching a portion and/or section of the pipeline from a remainder of the pipeline and/or from another structure, rotating the portion of the pipeline, and reattaching the portion of the pipeline to the remainder of the pipeline and/or the other structure. As discussed in more detail herein, an abrasive force between the slurry and the pipeline may be greatest on a bottom surface of the pipeline conduit. Thus, the rotating may increase wear uniformity about the circumference of the pipeline and/or increase the service life of the pipeline.

Repairing the energy dissipation layer at 255 may include the use of any suitable system, method, and/or structure to repair the energy dissipation layer. As an illustrative, non-exclusive example, and when the energy dissipation layer is configured to be separated from the pipeline, the repairing may include removing the energy dissipation layer from the pipeline conduit, repairing and/or strengthening a damaged, or worn, portion of the energy dissipation layer, and replacing the energy dissipation layer back into the pipeline conduit. As another illustrative, non-exclusive example, the repairing may include repairing and/or strengthening the damaged, or worn, portion of the energy dissipation layer while the energy dissipation layer is within the pipeline conduit.

Removing and replacing the energy dissipation layer at 260 may include removing the energy dissipation layer from the pipeline conduit and replacing the energy dissipation layer with a new energy dissipation layer and/or installing the new energy dissipation layer within the pipeline conduit. It is within the scope of the present disclosure that the removing may include pigging at least a portion of an existing energy dissipation layer from the inner surface of the pipe and/or sliding the existing energy dissipation layer from within the pipeline conduit.

It is further within the scope of the present disclosure that installing the new energy dissipation layer may include spraying the new energy dissipation layer onto the inner surface of the pipe. The installing further may include pigging at least a portion of the new energy dissipation layer from the pipeline conduit to produce and/or define the central region of the pipeline conduit. Additionally or alternatively, the installing also may include inserting and/or sliding the new energy dissipation layer into the pipeline conduit.

Replacing the pipeline at 265 may include replacing any suitable portion and/or section of the pipeline. It is within the scope of the present disclosure that the replacing may be performed based, at least in part, on a specified time interval, measurement of one or more characteristics of the pipeline, and/or subsequent to rotation of the pipeline about the entire circumference of the pipeline.

It is within the scope of the present disclosure that the systems and methods that have been discussed and/or illustrated herein may be implemented and/or utilized with a slurry that comprises a gas and solid particles as primary components, as opposed to the previously discussed slurry 40 that comprises a liquid and solid particles as primary components. An illustrative, non-exclusive example of such a gas is carbon dioxide, including (but not limited to) carbon dioxide in a supercritical state. Thus, the present disclosure additionally or alternatively may be referred to as including a slurry that comprises a fluid and solid particles and/or which includes a slurry that includes a fluid and solid particles as primary components.

In the above discussion, a number of parameters are discussed in the context of average values, illustrative, non-exclusive examples of which include average flow rates, average flow velocities, and/or average dimensions. It is within the scope of the present disclosure that these averages may include any suitable average, illustrative, non-exclusive examples of which include means, medians, and/or modes.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

Illustrative, non-exclusive examples of systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. A pipeline configured to transfer a slurry, wherein the slurry includes a liquid and solid particles, the pipeline comprising:

a pipe including a pipe inner surface, wherein the pipe inner surface defines a pipeline conduit that is configured to convey the slurry; and

an energy dissipation layer proximal to the pipe inner surface and bounding at least a portion of a central region of the pipeline conduit, wherein the energy dissipation layer is configured to decrease the kinetic energy of a buffer portion of the slurry that flows through the energy dissipation layer relative to the kinetic energy of a central portion of the slurry that includes a remainder of the slurry and flows through the central region of the pipeline conduit.

A2. The pipeline of paragraph A1, wherein the energy dissipation layer is configured to at least one of, and optionally at least two, at least three, or at least four of, decrease an average velocity of the buffer portion, decrease an average velocity of a portion of the solid particles present within the buffer portion, decrease an average volumetric flow rate of the buffer portion, and decrease turbulence in the buffer portion.

A3. The pipeline of any of paragraphs A1-A2, wherein the energy dissipation layer is configured to decrease the kinetic energy of the buffer portion while providing for at least one of flow and substantial flow of the buffer portion therethrough, and optionally wherein the energy dissipation layer is configured to decrease the kinetic energy of the buffer portion without at least one of blocking, occluding, and stopping the flow of the buffer portion therethrough.

A4. The pipeline of any of paragraphs A1-A3, wherein the energy dissipation layer is configured to decrease a rate at which the slurry erodes the pipe, and optionally wherein the energy dissipation layer is configured to decrease the rate at which the slurry erodes the pipe without substantially decreasing at least one of a flow rate and an average velocity of the central portion of the slurry.

A5. The pipeline of any of paragraphs A1-A4, wherein the buffer portion includes an average buffer portion volumetric flow rate, wherein the central portion includes an average central portion volumetric flow rate, and further wherein the energy dissipation layer is configured to decrease the average buffer portion volumetric flow rate relative to the average central portion volumetric flow rate by a reduction fraction.

A6. The pipeline of any of paragraphs A1-A5, wherein the buffer portion includes an average buffer portion flow velocity, wherein the central portion includes an average central portion flow velocity, and further wherein the energy dissipation layer is configured to decrease the average buffer portion flow velocity relative to the average central portion flow velocity by a/the reduction fraction.

A7. The pipeline of any of paragraphs A5-A6, wherein the reduction fraction is greater than or equal to 0.2, 0.3, 0.4, 0.5, 0.6, 0.7, 0.75, 0.8, 0.85, 0.9, 0.92, 0.94, 0.96, 0.98, 0.99, and optionally wherein the reduction fraction is less than or equal to 0.995, 0.99, 0.95, 0.9, 0.8, 0.7, 0.6, 0.5, or 0.4.

A8. The pipeline of any of paragraphs A1-A7, wherein the buffer portion is configured to reduce the kinetic energy of impinging solid particles of the slurry that enter the buffer portion from the central region of the pipeline conduit, and optionally wherein the buffer portion is configured to absorb a portion of the kinetic energy of the impinging solid particles.

A9. The pipeline of paragraph A8, wherein the buffer portion is configured to absorb the portion of the kinetic energy without substantial abrasive wear of at least one of the pipe and the energy dissipation layer, optionally without substantial abrasive wear of the pipe, and further optionally without abrasive wear of the pipe.

A10. The pipeline of any of paragraphs A1-A9, wherein the pipeline includes a total volume of the slurry, wherein the buffer portion includes less than 25%, less than 20%, less than 15%, less than 12.5%, less than 10%, less than 7.5%, less than 5%, or less than 2% of the total volume of the slurry, and optionally wherein the buffer portion includes at least 0.5%, at least 1%, at least 2.5%, at least 5%, at least 7.5%, or at least 10% of the total volume of the slurry.

A11. The pipeline of any of paragraphs A1-A10, wherein the energy dissipation layer includes a plurality of flow obstructions that is configured to decrease the kinetic energy of the buffer portion, and optionally wherein the plurality of flow obstructions is configured to decrease the kinetic energy of the buffer portion without at least one of trapping, blocking, stopping, and occluding flow of the buffer portion of the slurry.

A12. The pipeline of any of paragraphs A1-A11, wherein the energy dissipation layer includes a porous structure.

A13. The pipeline of paragraph A12, wherein the porous structure includes a porosity of at least 50%, at least 60%, at least 70%, at least 75%, at least 80%, at least 85%, at least 90%, at least 95%, at least 99%, or at least 99.9%, and optionally wherein the porous structure includes a porosity of less than 100%, less than 99.9%, less than 99%, less than 98%, less than 97%, less than 96%, or less than 95%.

A14. The pipeline of any of paragraphs A12-A13, wherein the porous structure includes a plurality of pores, optionally wherein the plurality of pores includes a plurality of interconnected pores, and further optionally wherein less than 25%, less than 20%, less than 15%, less than 10%, less than 5%, less than 1%, or none of the plurality of pores include isolated pores.

A15. The pipeline of any of paragraphs A12-A14, wherein the porous structure includes an average equivalent pore throat diameter, wherein the solid particles include an average equivalent particle diameter, and further wherein the average equivalent pore throat diameter is greater than the average equivalent particle diameter, and optionally wherein the average equivalent pore throat diameter is at least 5, at least 10, at least 20, at least 25, at least 50, at least 75, at least 100, at least 150, at least 200, at least 250, or at least 500 times larger than the average equivalent particle diameter.

A16. The pipeline of paragraph A15, wherein the equivalent pore throat diameter is defined as the diameter of a circle that has the same area as a representative pore throat cross-sectional area, and further wherein the equivalent particle diameter is defined as the diameter of a circle that has the same area as a representative particle cross-sectional area.

A17. The pipeline of any of paragraphs A15-A16, wherein the average equivalent pore throat diameter is greater than 50 micrometers, greater than 250 micrometers, greater than 1,000 micrometers, greater than 2,000 micrometers, greater than 5,000 micrometers, or greater than 20,000 micrometers.

A18. The pipeline of any of paragraphs A12-A17, wherein the porous structure includes at least one of an extruded structure, a honeycomb, a foam, a porous foam, a sintered structure, and a periodic structure.

A19. The pipeline of any of paragraphs A1-A18, wherein the energy dissipation layer includes at least one of a plurality of hollow-face, non-right-angle cuboids; a plurality of radially aligned spikes; a plurality of interconnected, radially aligned spikes; a plurality of wires; a network of intertwined wires; a network of unconnected but intertwined wires; wire fencing; and chain link fencing.

A20. The pipeline of any of paragraphs A1-A19, wherein the energy dissipation layer is concentric with at least a portion of the pipe, optionally wherein the energy dissipation layer is concentric with the pipe, optionally wherein the energy dissipation layer includes a hollow region that defines the central region of the pipeline conduit, optionally wherein the hollow region is concentric with at least a portion of the pipe, and further optionally wherein the hollow region is concentric with the pipe.

A21. The pipeline of any of paragraphs A1-A20, wherein the energy dissipation layer extends around a portion of a circumference of the pipe, optionally wherein the portion of the circumference includes a bottom surface of the pipeline conduit, optionally wherein the portion of the circumference includes a majority, at least 50%, at least 60%, at least 70%, at least 75%, at least 80%, at least 85%, at least 90%, at least 95%, at least 99%, or the entire circumference of the pipe, and further optionally wherein the energy dissipation layer is uniform around the circumference of the pipe.

A22. The pipeline of any of paragraphs A1-A21, wherein the energy dissipation layer extends along a portion of a length of the pipe, optionally wherein the portion includes a majority, at least 50%, at least 60%, at least 70%, at least 75%, at least 80%, at least 85%, at least 90%, at least 95%, at least 99%, or the entire of the length of the pipe, and further optionally wherein the energy dissipation layer is uniform along the length of the pipe.

A23. The pipeline of any of paragraphs A1-A22, wherein the pipeline includes a transition region, optionally wherein the transition region includes at least one of an entrance region that is configured to receive the slurry into the pipeline and a bend region that is configured to change an average flow direction of the slurry, wherein the transition region includes a transition region energy dissipation layer, optionally wherein the transition region energy dissipation layer is different from a remainder of the energy dissipation layer, and further optionally wherein the transition region energy dissipation layer includes at least one of a different thickness, a greater thickness, a different chemical composition, and a different porosity than the remainder of the energy dissipation layer.

A24. The pipeline of any of paragraphs A1-A23, wherein the energy dissipation layer includes an energy dissipation layer thickness, and optionally wherein the energy dissipation layer thickness is less than 500%, less than 200%, less than 100%, less than 75%, or less than 50% of a wall thickness of the pipe, and further optionally wherein the energy dissipation layer thickness is greater than 10%, greater than 25%, greater than 50%, greater than 75%, greater than 100%, or greater than 200% of the wall thickness of the pipe.

A25. The pipeline of paragraph A24, wherein the energy dissipation layer thickness is less than 20%, less than 10%, less than 7.5%, less than 5%, or less than 2.5% of a diameter of the pipe.

A26. The pipeline of any of paragraphs A24-A25, wherein the solid particles include an/the average equivalent particle diameter, and further wherein the energy dissipation layer thickness is at least 5, at least 10, at least 25, or at least 50 times the average equivalent particle diameter, and optionally wherein the energy dissipation layer thickness is less than 100, less than 50, less than 25, or less than 10 times the average equivalent particle diameter.

A27. The pipeline of any of paragraphs A1-A26, wherein the energy dissipation layer includes at least one of a ceramic, a porous ceramic, a foam, an expanded metal, a wire cloth, a metallic material, a polymeric material, high manganese steel, and a composite material.

A28. The pipeline of any of paragraphs A1-A27, wherein the pipeline includes an intermediate layer between the pipe inner surface and the energy dissipation layer, and optionally wherein the pipeline includes a plurality of intermediate layers.

A29. The pipeline of paragraph A28, wherein the intermediate layer includes at least one of an/another energy dissipation layer, a porous layer, an abrasion-resistant layer, a corrosion-resistant layer, an adhesive layer, a coating, and a void space.

A30. The pipeline of any of paragraphs A28-A29, wherein the intermediate layer includes an intermediate layer porosity that is less than a/the porosity of the energy dissipation layer, and optionally wherein the intermediate layer porosity is less than 40%, less than 35%, less than 30%, less than 25%, less than 20%, less than 15%, less than 10%, less than 5%, less than 1%, or substantially zero.

A31. The pipeline of any of paragraphs A1-A30, wherein the energy dissipation layer includes at least one of a compliant structure and a resilient structure, and optionally wherein the energy dissipation layer is configured to at least one of bend, flex, and deform responsive to mechanical contact between the energy dissipation layer and a portion of the slurry.

A32. The pipeline of any of paragraphs A1-A31, wherein the pipe and the energy dissipation layer form a composite structure.

A33. The pipeline of any of paragraphs A1-A32, wherein the energy dissipation layer is formed separately from the pipe and placed within the pipeline conduit during assembly of the pipeline.

A34. The pipeline of any of paragraphs A1-A32, wherein the energy dissipation layer is formed within the pipe, and optionally wherein the energy dissipation layer includes a foam that is sprayed into the pipe.

A35. The pipeline of any of paragraphs A32-A34, wherein an outer diameter of the energy dissipation layer is less than or equal to an inner diameter of the pipe, and optionally wherein the outer diameter of the energy dissipation layer is within 20%, 15%, 10%, 5%, 2.5%, or 1% of the inner diameter of the pipe.

A36. The pipeline of any of paragraphs A1-A35, wherein the energy dissipation layer is not affixed to the pipe inner surface.

A37. The pipeline of any of paragraphs A1-A35, wherein the energy dissipation layer is operatively attached to the pipe inner surface, and optionally wherein the energy dissipation layer is operatively attached to the pipe inner surface using at least one of an adhesive, an adhesive bond, an epoxy, a weld, brazing, a friction fit, and a fastener.

A38. The pipeline of any of paragraphs A1-A31, wherein the pipe and the energy dissipation layer form a monolithic structure.

A39. The pipeline of paragraph A38, wherein the energy dissipation layer is formed by removing material from the pipe inner surface, and optionally wherein the energy dissipation layer is formed by at least one of cutting, etching, and machining to remove the material from the pipe inner surface.

A40. The pipeline of any of paragraphs A1A39, wherein the pipe is a metallic pipe.

A41. The pipeline of any of paragraphs A1-A40, wherein a length of the pipe is at least 0.5 kilometers, at least 1 kilometer, at least 2 kilometers, at least 3 kilometers, at least 4 kilometers, at least 5 kilometers, at least 7.5 kilometers, at least 10 kilometers, at least 15 kilometers, at least 25 kilometers, or at least 50 kilometers.

A42. The pipeline of any of paragraphs A1-A41, wherein an/the inner diameter of the pipe is at least 0.25 meters, at least 0.5 meters, at least 0.75 meters, or at least 1 meter, and optionally wherein the inner diameter of the pipe is less than 2 meters, less than 1.75 meters, less than 1.5 meters, less than 1.25 meters, or less than 1 meter.

A43. The pipeline of any of paragraphs A1-A42, wherein the liquid includes at least one of water, bitumen, and a liquid hydrocarbon.

A44. The pipeline of any of paragraphs A1-A43, wherein the solid particles comprise at least 5, at least 10, at least 15, at least 20, at least 25, at least 30, at least 35, at least 40, at least 45, at least 50, or at least 55 volume percent of the slurry, and optionally wherein the solid particles comprise less than 70, less than 65, less than 60, less than 55, less than 50, less than 45, or less than 40 volume percent of the slurry.

A45. The pipeline of any of paragraphs A1-A44, wherein the solid particles include at least one of sand, clay, rock, hydrocarbon ore, and mine tailings.

A46. The pipeline of any of paragraphs A1-A45, wherein the slurry includes a hydrocarbon, optionally wherein the hydrocarbon includes at least 0.25, at least 0.5, at least 1, at least 2, at least 3, at least 5, at least 10, at least 15, at least 20, at least 25, at least 30, or at least 35 volume percent of the slurry, optionally wherein the hydrocarbon includes less than 50, less than 45, less than 40, less than 35, less than 30, or less than 25 volume percent of the slurry, and further optionally wherein the hydrocarbon includes bitumen.

A47. The pipeline of any of paragraphs A1-A46, wherein the slurry includes an average slurry flow velocity within the pipeline, optionally wherein the average slurry flow velocity is at least 0.5, at least 1, at least 2, at least 3, at least 4, at least 5, at least 6, or at least 7 meters per second, and further optionally wherein the average slurry flow velocity is less than 10, less than 7, less than 6, less than 5, less than 4, less than 3, or less than 2 meters per second.

A48. The pipeline of paragraph A47, wherein the buffer portion includes an average buffer portion flow velocity, optionally wherein the average buffer portion flow velocity is less than 1%, less than 5%, less than 10%, less than 20%, less than 30%, less than 40%, less than 50%, less than 60%, less than 70%, less than 80%, less than 90%, or less than 95% of the average slurry flow velocity, and further optionally wherein the average buffer portion flow velocity is at least 0.1%, at least 1%, at least 5%, at least 10%, at least 20%, at least 30%, at least 40%, at least 50%, at least 60%, or at least 70% of the average slurry flow velocity.

A49. The pipeline of any of paragraphs A1-A48, wherein the slurry includes at least one of a caustic material, a caustic soda, sodium hydroxide, and/or naphthalic acid.

A50. The pipeline of any of paragraphs A1-A49, wherein at least a turbulent flow portion of the slurry flows within the pipeline under turbulent flow conditions, optionally wherein the turbulent flow portion of the slurry includes at least 30%, at least 40%, at least 50%, at least 60%, at least 70%, at least 80%, at least 90%, or at least 95% of a total volume of the slurry within the pipeline, and further optionally wherein the turbulent flow portion of the slurry includes less than 99.9%, less than 99.5%, less than 99%, less than 97.5%, less than 95%, less than 90%, less than 85%, less than 80%, or less than 75% of the total volume of the slurry within the pipeline.

A51. The pipeline of any of paragraphs A2-A50, wherein the average includes at least one of a mean, a median, and a mode, and optionally wherein the slurry includes a bulk flow direction and the average is measured in the bulk flow direction.

A52. The pipeline of any of paragraphs A1-A51, wherein the pipeline is configured to transfer the slurry between a first location and a second location, and optionally wherein at least one of the first location and the second location includes at least one of a mine, a hydrocarbon mine, an ore processing facility, a hydrocarbon ore processing facility, a mine tailings disposal site, and a tailings pond.

A53. The pipeline of any of paragraphs A1-A52, wherein the energy dissipation layer includes a means for reducing an average velocity of the buffer portion of the slurry.

A54. The pipeline of paragraph A53, wherein the means for reducing is configured to decrease the average velocity of the buffer portion of the slurry by a reduction fraction relative to an average velocity of a similar portion of a similar slurry flowing through a similar pipeline that includes the pipeline conduit but does not include the means for reducing.

B1. A method for decreasing abrasive wear of a pipeline that is configured to transfer a slurry, wherein the slurry includes a liquid and solid particles, wherein the pipeline includes a pipe including a pipe inner surface that defines a pipeline conduit and an energy dissipation layer that is proximal to the pipe inner surface, wherein the energy dissipation layer bounds at least a portion of a central region of the pipeline conduit, wherein a buffer portion of the slurry flows through the energy dissipation layer, and further wherein a central portion of the slurry that includes a remainder of the slurry flows through the central region of the pipeline conduit, the method comprising:

flowing the slurry through the pipeline conduit; and

decreasing a kinetic energy of the buffer portion of the slurry relative to the kinetic energy of the central portion of the slurry to decrease abrasion of the pipeline conduit by the slurry.

B2. The method of paragraph B1, wherein the decreasing includes reducing an average velocity of the buffer portion of the slurry, optionally wherein the reducing includes reducing the average velocity by at least 20%, at least 30%, at least 40%, at least 50%, at least 60%, at least 75%, at least 80%, at least 85%, at least 90%, at least 92%, at least 94%, at least 96%, at least 98%, or at least 99%, and further optionally wherein the reducing includes reducing the average velocity by less than 99.5%, less than 99%, less than 95%, less than 90%, less than 80%, less than 70%, less than 60%, less than 50%, or less than 40%.

B3. The method of any of paragraphs B1-B2, wherein the method includes decreasing the kinetic energy of impinging solid particles of the slurry that enter the buffer portion from the central region of the pipeline conduit, and optionally wherein the decreasing includes absorbing a portion of the kinetic energy of the impinging solid particles with at least one of the buffer portion and the energy dissipation layer.

B4. The method of paragraph B3, wherein the energy dissipation layer includes a resilient structure, and further wherein the absorbing includes deforming the energy dissipation layer, at least temporarily, with the impinging solid particles.

B5. The method of any of paragraphs B1-B4, wherein the pipeline includes a total volume of the slurry, wherein the flowing includes flowing the buffer portion of the slurry, optionally wherein the buffer portion includes less than 25%, less than 20%, less than 15%, less than 12.5%, less than 10%, less than 7.5%, less than 5%, or less than 2% of the total volume of the slurry, and further optionally wherein the buffer portion includes at least 0.5%, at least 1%, at least 2.5%, at least 5%, at least 7.5%, or at least 10% of the total volume of the slurry.

B6. The method of any of paragraphs B1-B5, wherein an abrasive force that is generated by flowing the slurry through the pipeline is greatest on a bottom surface of the pipeline conduit, and further wherein the method includes periodically rotating the pipeline to increase wear uniformity about a circumference of the pipeline.

B7. The method of any of paragraphs B1-B6, wherein the method further includes repairing the energy dissipation layer, and optionally wherein the repairing includes removing the energy dissipation layer from the pipeline, repairing the energy dissipation layer, and placing the energy dissipation layer within the pipeline.

B8. The method of any of paragraphs B1-B7, wherein the method further includes periodically replacing at least one of the pipeline, the pipe, and the energy dissipation layer, and optionally wherein the periodically replacing is performed subsequent to rotating the pipeline about an entire circumference of the pipeline.

B9. The method of any of paragraphs B1-B8, wherein the method includes removing the energy dissipation layer from the pipeline and installing a new energy dissipation layer within the pipeline.

B10. The method of paragraph B9, wherein the removing includes at least one of pigging at least a portion of the existing energy dissipation layer from the pipe inner surface and sliding the existing energy dissipation layer from within the pipe.

B11. The method of any of paragraphs B9-B10, wherein the installing includes spraying the new energy dissipation layer onto the pipe inner surface, and optionally wherein the method further includes pigging a portion of the new energy dissipation layer from the pipe to define the central region of the pipeline conduit.

B12. The method of any of paragraphs B9-B11, wherein the installing includes at least one of inserting and sliding the new energy dissipation layer into the pipe.

B13. The method of any of paragraphs B1-B12, wherein the method further includes maintaining a turbulent flow regime within a turbulent flow portion of the slurry, and optionally wherein the turbulent flow portion of the slurry includes at least 30%, at least 40%, at least 50%, at least 60%, at least 70%, at least 80%, least 90% , or at least 95% of a/the total volume of the slurry that is within the pipeline, and further optionally wherein the turbulent flow portion of the slurry includes less than 99.9%, less than 99.5%, less than 99%, less than 97.5%, less than 95%, less than 90%, less than 85%, less than 80%, or less than 75% of the total volume of the slurry that is within the pipeline.

B14. The method of any of paragraphs B1-B13, wherein the method further includes separating a first slurry component from a second slurry component during the flowing, and optionally wherein the separating includes separating at least one of a hydrocarbon and bitumen from sand.

B15. The method of any of paragraphs B1-B14, wherein the method further includes assembling the pipeline, and optionally wherein the assembling includes attaching a plurality of pipe segments to one another to form the pipe.

B16. The method of paragraph B15, wherein the method further includes at least one of inserting and sliding the energy dissipation layer into the pipe.

B17. The method of paragraph B15, wherein the method further includes forming the energy dissipation layer within the pipe.

B18. The method of any of paragraphs B1-B17, wherein the liquid includes at least one of water, bitumen, and a liquid hydrocarbon, and further wherein flowing the slurry includes flowing the liquid.

B19. The method of any of paragraphs B1-B18, wherein the solid particles comprise at least 5, at least 10, at least 15, at least 20, at least 25, at least 30, at least 35, at least 40, at least 45, at least 50, or at least 55 volume percent of the slurry, optionally wherein the solid particles comprise less than 70, less than 65, less than 60, less than 55, less than 50, less than 45, or less than 40 volume percent of the slurry, and further wherein flowing the slurry includes flowing the solid particles.

B20. The method of any of paragraphs B1-B19, wherein the solid particles include at least one of sand, clay, rock hydrocarbon ore, and mine tailings, and further wherein flowing the slurry includes flowing the solid particles.

B21. The method of any of paragraphs B1-B20, wherein the slurry includes a hydrocarbon, optionally wherein the hydrocarbon includes at least 0.25, at least 0.5, at least 1, at least 2, at least 3, at least 5, at least 10, at least 15, at least 20, at least 25, at least 30, or at least 35 volume percent of the slurry, optionally wherein the hydrocarbon includes less than 50, less than 45, less than 40, less than 35, less than 30, or less than 25 volume percent of the slurry, optionally wherein the hydrocarbon includes bitumen, and further wherein flowing the slurry includes flowing the hydrocarbon.

B22. The method of any of paragraphs B1-B21, wherein flowing the slurry includes flowing the slurry with an average slurry flow velocity within the pipeline, optionally wherein the average slurry flow velocity is at least 0.1, at least 1, at least 2, at least 3, at least 4, at least 5, at least 6, or at least 7 meters per second, and further optionally wherein the average slurry flow velocity is less than 10, less than 7, less than 6, less than 5, less than 4, less than 3, less than 2, or less than 1 meters per second.

B23. The method of paragraph B22, wherein flowing the slurry includes flowing the buffer portion with an average buffer portion flow velocity, optionally wherein the average buffer portion flow velocity is less than 1%, less than 5%, less than 10%, less than 20%, less than 30%, less than 40%, less than 50%, less than 60%, less than 70%, less than 80%, less than 90%, or less than 95% of the average slurry flow velocity, and further optionally wherein the average buffer portion flow velocity is at least 0.1%, at least 1%, at least 5%, at least 10%, at least 20%, at least 30%, at least 40%, at least 50%, at least 60%, or at least 70% of the average slurry flow velocity.

B24. The method of any of paragraphs B1-B23, wherein the slurry includes a separation-enhancing component, optionally wherein the separation-enhancing component includes at least one of a caustic material, a caustic soda, sodium hydroxide, and/or naphthalic acid, and further wherein flowing the slurry includes flowing the separation-enhancing component.

B25. The method of any of paragraphs B1-B24, wherein at least a turbulent flow portion of the slurry flows within the pipeline under turbulent flow conditions, optionally wherein the turbulent flow portion of the slurry includes at least 30%, at least 40%, at least 50%, at least 60%, at least 70%, at least 80%, at least 90%, or at least 95% of a/the total volume of the slurry within the pipeline, and further optionally wherein the turbulent flow portion of the slurry includes less than 99.9%, less than 99.5%, less than 99%, less than 97.5%, less than 95%, less than 90%, less than 85%, less than 80%, or less than 75% of the total volume of the slurry within the pipeline.

B26. The method of any of paragraphs B1-B25, wherein the energy dissipation layer includes a porous structure, and further wherein flowing the slurry includes flowing the buffer portion through the porous structure.

B27. The method of paragraph B26, wherein the porous structure includes a porosity of at least 50%, at least 60%, at least 70%, at least 75%, at least 80%, at least 85%, at least 90%, at least 95%, at least 99%, or at least 99.9%, and optionally wherein the porous structure includes a porosity of less than 100%, less than 99.9%, less than 99%, less than 98%, less than 97%, less than 96%, or less than 95%.

B28. The method of any of paragraphs B1-B27, wherein the pipeline includes the pipeline of any of paragraphs A1-A54.

C1. The use of any of the pipelines of any of paragraphs A1-A54 with any of the methods of any of paragraphs B1-B28.

C2. The use of any of the methods of any of paragraphs B1-B28 with any of the pipelines of any of paragraphs A1-A54.

C3. The use of any of the pipelines of any of paragraphs A1-A54 or any of the methods of any of paragraphs Bl-B28 to decrease wear within a pipeline due to flow of a slurry therethrough.

C4. The use of any of the pipelines of any of paragraphs A1-A54 or any of the methods of any of paragraphs B1-B28 to transfer a slurry between a first location and a second location.

C5. The use of any of the pipelines of any of paragraphs A1-A54 or any of the methods of any of paragraphs B1-B28;to mine hydrocarbons.

C6. The use of an energy dissipation layer to increase, optionally at least double, and further optionally at least triple, the service life of a pipeline that is configured to transfer a slurry.

C7. The use of an energy dissipation layer to produce a buffer portion of a slurry within a pipeline that is configured to transfer the slurry.

C8. The use of an energy dissipation layer to reduce erosion of a pipeline.

D1. The pipelines of any of paragraphs A1-A54, the methods of any of paragraphs B1-B28, and/or the uses of any of paragraphs C1-C8, wherein the slurry includes the liquid and the solid particles as primary components.

D2. The pipelines of any of paragraphs A1-A54, the methods of any of paragraphs B1-B28, and/or the uses of any of paragraphs C1-C8, wherein the slurry includes the liquid and the solid particles as primary components, and further wherein the slurry further comprises at least one additional component.

D3. The pipelines of any of paragraphs A1-A54, the methods of any of paragraphs B1-B28, and/or the uses of any of paragraphs C1-C8, wherein the slurry includes a gas instead of the liquid, and optionally wherein the slurry comprises the gas and the solid particles as primary components, and further optionally wherein the slurry further comprises at least one additional component.

D4. The pipelines, methods, and/or uses of paragraph D3, wherein the gas comprises carbon dioxide, optionally wherein the gas is carbon dioxide, and further optionally wherein the carbon dioxide is supercritical carbon dioxide.

PCT1. A pipeline configured to transfer a slurry, wherein the slurry includes a liquid and solid particles, the pipeline comprising:

pipe including a pipe inner surface, wherein the pipe inner surface defines a pipeline conduit that is configured to convey the slurry; and

an energy dissipation layer proximal to the pipe inner surface and bounding at least a portion of a central region of the pipeline conduit, wherein the energy dissipation layer includes a porous structure with a porosity of 70% to 99.9%, wherein the energy dissipation layer is configured to decrease the kinetic energy of a buffer portion of the slurry that flows through the energy dissipation layer relative to the kinetic energy of a central portion of the slurry that includes a remainder of the slurry and flows through the central region of the pipeline conduit.

PCT2. The pipeline of paragraph PCT1, wherein the energy dissipation layer is configured to decrease the kinetic energy of the buffer portion while providing for flow of the buffer portion therethrough, and further wherein the energy dissipation layer is configured to decrease the kinetic energy of the buffer portion without blocking the flow of the buffer portion therethrough.

PCT3. The pipeline of any of paragraphs PCT1-PCT2, wherein the energy dissipation layer is configured to decrease a rate at which the slurry erodes the pipe without substantially decreasing a flow rate of the central portion of the slurry.

PCT4. The pipeline of any of paragraphs PCT1-PCT3, wherein the buffer portion is configured to reduce the kinetic energy of impinging solid particles of the slurry that enter the buffer portion from the central region of the pipeline conduit.

PCT5. The pipeline of any of paragraphs PCT1-PCT4, wherein the porous structure includes an average equivalent pore throat diameter, wherein the solid particles include an average equivalent particle diameter, and further wherein the average equivalent pore throat diameter is at least 5 times greater than the average equivalent particle diameter.

PCT6. The pipeline of any of paragraphs PCT1-PCT5, wherein the energy dissipation layer is concentric with at least a portion of the pipe, and further wherein the energy dissipation layer extends around at least 80% of a circumference of the pipe.

PCT7. The pipeline of any of paragraphs PCT1-PCT6, wherein the pipe has a length, and the energy dissipation layer extends along at least 50% of the length of the pipe.

PCT8. The pipeline of any of paragraphs PCT1-PCT7, wherein the energy dissipation layer includes an energy dissipation layer thickness, wherein the pipe includes a pipe wall thickness, and further wherein the energy dissipation layer thickness is 50%-150% of the pipe wall thickness.

PCT9. The pipeline of any of paragraphs PCT1-PCT8, wherein the pipe has a length, and the length of the pipe is at least 1 kilometer.

PCT10. A method for decreasing abrasive wear of a pipeline that is configured to transfer a slurry, wherein the slurry includes a liquid and solid particles, wherein the pipeline includes a pipe including a pipe inner surface that defines a pipeline conduit and an energy dissipation layer that is proximal to the pipe inner surface, wherein the energy dissipation layer bounds at least a portion of a central region of the pipeline conduit, wherein a buffer portion of the slurry flows through the energy dissipation layer, and further wherein a central portion of the slurry that includes a remainder of the slurry flows through the central region of the pipeline conduit, the method comprising:

flowing the slurry through the pipeline conduit, wherein the slurry includes a hydrocarbon, and further wherein the hydrocarbon includes at least 0.5 volume percent of the slurry; and

decreasing a kinetic energy of the buffer portion of the slurry relative to the kinetic energy of the central portion of the slurry to decrease abrasion of the pipeline conduit by the slurry.

PCT11. The method of paragraph PCT10, wherein the liquid includes at least one of water, bitumen, and a liquid hydrocarbon, and further wherein flowing the slurry includes flowing the liquid.

PCT12. The method of any of paragraphs PCT10-PCT11, wherein the solid particles comprise at least 15 volume percent of the slurry, and further wherein flowing the slurry includes flowing the solid particles.

PCT13. The method of any of paragraphs PCT10-PCT12, wherein the solid particles include at least one of sand, clay, rock, hydrocarbon ore, and mine tailings, and further wherein flowing the slurry includes flowing the solid particles.

PCT14. The method of any of paragraphs PCT10-PCT13, wherein flowing the slurry includes flowing the slurry with an average slurry flow velocity within the pipeline, wherein the average slurry flow velocity is at least 2 meters per second.

PCT15. The method of any of paragraphs PCT10-PCT14, wherein the energy dissipation layer includes a porous structure, wherein flowing the slurry includes flowing the buffer portion through the porous structure, and further wherein the porous structure includes a porosity of 70 to 99.9%.

### INDUSTRIAL APPLICABILITY

The systems and methods disclosed herein are applicable to the oil and gas industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A pipeline configured to transfer a slurry, wherein the slurry includes a liquid and solid particles, the pipeline comprising:
a pipe including a pipe inner surface, wherein the pipe inner surface defines a pipeline conduit that is configured to convey the slurry; and
an energy dissipation layer proximal to the pipe inner surface and bounding at least a portion of a central region of the pipeline conduit, wherein the energy dissipation layer includes a porous structure with a porosity of 70% to 99.9%, wherein the energy dissipation layer is configured to decrease a kinetic energy of a buffer portion of the slurry that flows through the energy dissipation layer relative to a kinetic energy of a central portion of the slurry that includes a remainder of the slurry and flows through the central region of the pipeline conduit.

2. The pipeline of claim 1, wherein the energy dissipation layer is configured to decrease the kinetic energy of the buffer portion while providing for flow of the buffer portion through the pipe, and wherein the energy dissipation layer is configured to decrease the kinetic energy of the buffer portion without blocking flow of the buffer portion through the pipe.

3. The pipeline of claim 1, wherein the energy dissipation layer is configured to decrease a rate at which the slurry erodes the pipe without substantially decreasing a flow rate of the central portion of the slurry.

4. The pipeline of claim 1, wherein the buffer portion is configured to reduce the kinetic energy of impinging solid particles of the slurry that enter the buffer portion from the central region of the pipeline conduit.

5. The pipeline of claim 1, wherein the porous structure includes an average equivalent pore throat diameter, wherein the solid particles include an average equivalent particle diameter, and wherein the average equivalent pore throat diameter is at least 5 times greater than the average equivalent particle diameter.

6. The pipeline of claim 5, wherein the average equivalent pore throat diameter is greater than 500 micrometers.

7. The pipeline of claim 1, wherein the porous structure includes at least one of an extruded structure, a honeycomb, a foam, a porous foam, a sintered structure, and a periodic structure.

8. The pipeline of claim 1, wherein the energy dissipation layer includes at least one of a plurality of hollow-face, non-right-angle cuboids; a plurality of radially aligned spikes; a plurality of interconnected, radially aligned spikes; a plurality of wires; a network of intertwined wires; a network of unconnected but intertwined wires; wire fencing; and chain link fencing.

9. The pipeline of claim 1, wherein the energy dissipation layer is concentric with at least a portion of the pipe, and wherein the energy dissipation layer extends around at least 80% of a circumference of the pipe.

10. The pipeline of claim 1, wherein the energy dissipation layer extends along at least 50% of a length of the pipe.

11. The pipeline of claim 1, wherein the energy dissipation layer includes an energy dissipation layer thickness, wherein the pipe includes a pipe wall thickness, and wherein the energy dissipation layer thickness is 10%-500% the pipe wall thickness.

12. The pipeline of claim 11, wherein the energy dissipation layer thickness is less than 10% of a diameter of the pipe.

13. The pipeline of claim 1, wherein the energy dissipation layer includes at least one of a ceramic, a porous ceramic, a foam, expanded metal, wire cloth, a metallic material, a polymeric material, high manganese steel, and a composite material.

14. The pipeline of claim 1, wherein the pipe and the energy dissipation layer form a composite structure, and wherein the energy dissipation layer is at least one of (1) formed separately from the pipe and placed within the pipeline conduit during assembly of the pipeline and (2) formed within the pipe.

15. The pipeline of claim 1, wherein a length of the pipe is at least 1 kilometer.

16. A method for decreasing abrasive wear of a pipeline that is configured to transfer a slurry, wherein the slurry includes a liquid and solid particles, and wherein the pipeline includes the pipeline of claim 1, the method comprising:
flowing the slurry through the pipeline conduit, wherein the slurry includes a hydrocarbon, and wherein the hydrocarbon includes at least 0.5 volume percent of the slurry; and
decreasing the kinetic energy of the buffer portion of the slurry relative to the kinetic energy of the central portion of the slurry to decrease abrasion of the pipeline conduit by the slurry.

17. A method for decreasing abrasive wear of a pipeline that is configured to transfer a slurry, wherein the slurry includes a liquid and solid particles, wherein the pipeline includes a pipe including a pipe inner surface that defines a pipeline conduit and an energy dissipation layer that is proximal to the pipe inner surface, wherein the energy dissipation layer bounds at least a portion of a central region of the pipeline conduit, wherein the slurry comprises a slurry buffer portion and a slurry central portion, the method comprising:
flowing the slurry through the pipeline conduit, wherein the slurry includes a hydrocarbon, wherein the hydrocarbon includes at least 0.5 volume percent of the slurry, and wherein flowing the slurry through the pipeline conduit comprises flowing the slurry central portion through the central region of the pipeline conduit and flowing the slurry buffer portion through the energy dissipation layer; and
decreasing a kinetic energy of the slurry buffer portion relative to a kinetic energy of the slurry central portion to decrease abrasion of the pipeline conduit by the slurry.

18. The method of claim 17, wherein the liquid includes at least one of water, bitumen, and a liquid hydrocarbon, and wherein flowing the slurry through the pipeline conduit further comprises flowing the liquid.

19. The method of claim 17, wherein the solid particles comprise at least 15 volume percent of the slurry, and wherein flowing the slurry through the pipeline conduit further comprises flowing the solid particles.

20. The method of claim 17, wherein the solid particles include at least one of sand, clay, rock, hydrocarbon ore, and mine tailings, and wherein flowing the slurry through the pipeline conduit further comprises flowing the solid particles.

21. The method of claim 17, wherein flowing the slurry through the pipeline conduit further comprises flowing the slurry with an average slurry flow velocity within the pipeline, wherein the average slurry flow velocity is at least 2 meters per second.

22. The method of claim 17, wherein the slurry includes a separation-enhancing component, and wherein flowing the slurry through the pipeline conduit further comprises flowing the separation-enhancing component.

23. The method of claim 17, wherein the energy dissipation layer includes a porous structure and wherein the porous structure includes a porosity of 70 to 99.9%.
